(19) United States
(12) Patent Application Publication
(10) Pub. No.: US 2018/0240348 A1
(43) Pub. Date: Aug. 23, 2018

(54) METHODS AND SYSTEMS FOR PROBABILISTIC SPACING ADVISORY TOOL (PSAT)

(71) Applicant: General Electric Company, Schenectady, NY (US)

(72) Inventor: Liling REN, Rexford, NY (US)

(21) Appl. No.: 15/435,653

(22) Filed: Feb. 17, 2017

(51) Int. Cl. G08G 5/00

(52) U.S. Cl. CPC G08G 5/0043; G08G 5/0034

(57) ABSTRACT

A method, medium, and system are provided comprising: receiving airspace data, weather data, and flight data at a spacing advisor module, the airspace data, weather data and flight data related to a plurality of flights; generating, via a trajectory modeler, a predicted trajectory for each of the flights of the plurality of flights to a target area; calculating a desired spacing for at least one of the points along a reference flight path; manipulating a trajectory for at least one of the first flight and the second flight based on the desired spacing; generating a target spacing, via the spacing advisor module, associated with a first flight and a second flight of the plurality of flights based on the received data, the generated predicted trajectory, and the manipulation of the predicted trajectory, wherein the target spacing is a distance between the second flight and a second meter point when the first flight passes a first meter point; and operating at least one of a first aircraft associated with the first flight and a second aircraft associated with the second flight based on the generated target spacing. Numerous other aspects are provided.

### BACKGROUND

The present disclosure relates to air traffic management, and in particular to managing trajectories for a mixed fleet of Performance Based Navigation (PBN) capable aircraft and non-PBN aircraft based on probabilistic properties of trajectory predictions.

In conventional operations, an aircraft's flight may generally follow a path defined by radio navigation beacons. Thus, such flight paths are often not the most direct route to a target since only a limited number of radio navigation beacons may be listed and shared by all flights in the airspace. Area navigation (RNAV) provides a means for an aircraft to know its location at any given moment of time so the aircraft may be navigated from its origin to its destination along a path defined by navigation fixes that are not necessarily coincident with radio navigation beacons, resulting in more consistent and more direct routes. Required Navigation Performance (RNP), a technology enabled by satellite based navigation, allows an aircraft to fly a RNAV path, including curved segments, with high precision. This technology allows for the flight path to be precisely planned and further optimized to enhance safety, be more direct and improve efficiency. Coupled with the Vertical Navigation (VNAV) capability provided by the Flight Management System (FMS) on board the aircraft, RNP/RNAV procedures, or PBN procedures, are viewed as the future of flight navigation.

However, one problem with the implementation of the PBN is that there may be multiple flights in an airspace to compete for the same resource(s). Without coordination in advance, air traffic controllers may have to vector aircraft by instructing one or more aircraft of specific tactical speed, altitude, and heading commands to the aircraft so that a safe separation between multiple aircraft may be maintained at all times. In a terminal area, this may mean flight path stretches and level flight segments, whose exact occurrence and parameters cannot be predicted in advance. In some instances, given the uncertainties in arrival time and trajectory of an aircraft, the skill of the air traffic controller to direct the aircraft may be heavily depended on. Also, although RNP/RNAV arrival and approach procedures may have already been developed for a destination terminal area, they are often not cleared for flights that are capable of flying these procedures and/or the flights may be vectored off the procedure flight path to address spacing between aircraft. As such, there may be a lower than desired utilization of the airborne capabilities and procedures that have already been deployed and future systems.

Therefore, it would be desirable to provide a system and method that can generate more efficient flight path trajectories for particular flights.

### BRIEF DESCRIPTION

According to some embodiments, a method is provided. The method includes receiving airspace data, weather data, and flight data at a spacing advisor module, the airspace data, weather data and flight data related to a plurality of flights; generating, via a trajectory modeler, a predicted trajectory for each of the flights of the plurality of flights to a target area; calculating a desired spacing for at least one of the points along a reference flight path; manipulating a trajectory for at least one of the first flight and the second flight based on the desired spacing; generating a target spacing, via the spacing advisor module, associated with a first flight and a second flight of the plurality of flights based on the received data, the generated predicted trajectory, and the manipulation of the predicted trajectory, wherein the target spacing is a distance between the second flight and a second meter point when the first flight passes a first meter point; and operating at least one of a first aircraft associated with the first flight and a second aircraft associated with the second flight based on the generated target spacing.

According to some embodiments, a system is provided. The system includes a configuration manager module to receive data, the configuration manager module operative to use the received data to: track a plurality of flights in a flight list via a flight list module; update an airspace model; update a weather model; a trajectory modeler operative to receive data from the configuration manager and update a flight trajectory for one or more flights in the flight list; a memory for storing program instructions; a spacing advisory tool processor, coupled to the memory, and in communication with the configuration manager module and the trajectory modeler and operative to execute program instructions to: receive data from the configuration manager and the trajectory modeler; calculating a desired spacing for at least one of the points along a reference flight path; manipulating a trajectory for at least one of the first flight and the second flight based on the desired spacing; and generate a target spacing associated with a first flight and a second flight of the plurality of flights, wherein the target spacing is a distance between the second flight and a second meter point when the first flight passes a first meter point, an optimizer to adjust operation of at least one of a first aircraft associated with the first flight and a second aircraft associated with the second flight is based on the generated target spacing.

According to some embodiments, a non-transitory computer-readable medium storing instructions is provided. When the instructions are executed by a computer processor, the instructions cause the computer processor to perform a method including receiving airspace data, weather data, and flight data at a spacing advisor module, the airspace data, weather data and flight data related to a plurality of flights; generating, via a trajectory modeler, a predicted trajectory for each of the flights of the plurality of flights to a target area; calculating desired spacing for at least one of the points along a reference flight path; manipulating a trajectory for at least one of the first flight and the second flight based on the desired spacing; generating a target spacing, via the spacing advisor module, associated with a first flight and a second flight of the plurality of flights based on the received data and the generated predicted trajectory, wherein the target spacing is a distance between the second flight and a second meter point when the first flight passes a first meter point; and operating at least one of a first aircraft associated with the first flight and a second aircraft associated with the second flight based on the generated target spacing.

A technical effect of some embodiments of the invention is an improved and/or computerized technique and system for determining probabilistic target spacing dynamically in real time between pairs of flights at arrival meter points so that sequencing and spacing of the arrival flow (both single-file and merging) of pairs of flights may be optimized. Embodiments provide for the distribution of the spacing as advisories to a flight crew, the Air Navigation Service Provider (ANSP), and aircraft operations control centers so that actions may be taken to increase the probability that appropriately equipped aircraft may fly an RNP approach in a mixed equipage terminal environment, within which both RNP/RNAV approaches and non-RNAV approaches are operated at the same time. Embodiments provide for a unique airspace model structure and analysis framework to handle single-file traffic and merging traffic in a unified manner. With these and other advantages and features that will become hereinafter apparent, a more complete understanding of the nature of the invention may be obtained by referring to the following detailed description and to the drawings appended hereto.

Other embodiments are associated with systems and/or computer-readable medium storing instructions to perform any of the methods described herein.

### DRAWINGS

FIG. 1 is an illustrative depiction of an airspace, highlighting some aspects of target spacing, in accordance with some embodiments.

FIG. 2 is an illustrative depictive a system, in accordance with some embodiments.

FIG. 3 is a flow chart in accordance with some embodiments.

FIG. 4 is a graph illustrating trajectories of a pair of consecutive flights with known trajectories.

FIG. 5A is a graph illustrating trajectories of a pair of consecutive flights with potential trajectory uncertainties.

FIG. 5B is a graph illustrating a prior art [Ren 2007] target spacing determination for a pair of flights on the same path.

FIG. 6 is a graph illustrating trajectory variation for the pair of flights on the same path and a separation buffer in accordance with some embodiments.

FIG. 7 is a graph illustrating the general case of target spacing for a pair of flights either on the same path or different paths, to the same runway or different runways, in accordance with some embodiments.

FIG. 8A is a spacing advisory matrix in accordance with some embodiments.

FIG. 8B is a table in accordance with some embodiments.

FIG. 9 is a block diagram of a system according to some embodiments.

### DETAILED DESCRIPTION

As aircraft are reaching an airport, they may be assigned a certain path to a runway, based on runway configurations, other aircraft and weather conditions, for example. As the aircraft approach the runways, their speed may decrease when descending from a higher altitude to a lower altitude (e.g., from 150 nautical miles at 37,000 feet to 15 nautical miles at 3,000 feet), and the aircraft may get closer together, similar to when several cars are approaching a toll on a highway. This is commonly referred to as compression. For safety, the aircraft are required to maintain separation, a specific distance or space from each other. Conventionally, air traffic controllers determine, in many instances manually, whether an aircraft needs to speed up/slow down, change course to stretch the flight path, or even maintain a holding pattern to maintain the required distance.

One or more embodiments provide for using a spacing advisor module as part of a probabilistic spacing advisory tool (PSAT) to calculate how far apart aircraft should be from each other at a higher altitude (e.g., target spacing), so that the air traffic controller's manual intervention may be minimized when aircraft get closer to the airport. One or more embodiments provide for the target spacing at downstream meter points to be generated dynamically in real-time based on airspace model data, weather model data, flight data, and probabilistic trajectory data. One or more embodiments provide for managing air traffic via target spacing to reduce, for example, flight time, delay, along track miles, and fuel burn for a mixed fleet of Performance Based Navigation (PBN) aircraft that are capable of and expected to perform Required Navigation Performance (RNP) Area Navigation (RNAV) arrivals and approaches and non-PBN aircraft that are expected to perform conventional non-RNAV arrival and approaches.

In one or more embodiments, the target spacing may be determined for a specific pair of flights, specified by their respective origin and destination, current state, aircraft type, flight time, latest flight plan, weather updates (e.g., winds and pressure, etc.), and expected approach runway. In one or more embodiments, uncertainty factors that may influence aircraft trajectory in four-dimensional (4D) may be evaluated in real-time and may be taken into account in the determination of the target spacing.

One or more embodiments may provide for a spacing advisory matrix whereby multiple target spacing entries for a same flight pair (an ordered sequence of two flights) may be included. The multiple entries may account for controllable procedural elements (e.g., a flight may be assigned to one runway or another).

One or more embodiments may provide for target spacing for related flight pairs irrespective of whether the two flights are coming from same or different directions, going to the same or different runways or even the same or different airports. As used herein, “related” means that during a period of time, without limiting its duration or time of occurrence, the two flights may become a concern in terms of spacing within or around the destination terminal area. If the two flights are expected to cross the same meter point within a small enough time window (e.g., a few seconds to a number of minutes), they may be considered related because their spacing over that meter point may need to satisfy a minimum value for safe and efficient operations. As used herein, “meter point” may refer to a point near the boundary of a terminal airspace where the traffic flow may be regulated into the terminal airspace. Two flights may also be “related” if the two flights are expected to traverse a small block of airspace (e.g., a block defined by radar separation minima, e.g., 3 nautical miles laterally and 1,000 feet vertically. Other suitable airspace volume structure and characteristic lengths may be used.) within a small time window. Two flights may be “related” if they are expected to land to the same runway, closely spaced parallel runways, or crossing runways, within a small time window. In one or more embodiments, if any combination of the above conditions is expected the two flights are “related.”

Embodiments provide for the generated target spacing(s) to be used as input to one or more optimization processes (e.g., runway assignment, arrival sequencing and spacing, integrated arrival and departure schedule), the output of which may then be used in the operation of aircraft to provide the aforementioned reductions in flight time, delay, along track miles, and fuel burn. In some instances, the target spacing and/or optimization information may be shared with the aircraft operator's ground control personnel and/or air traffic management system and/or personnel for situation awareness, traffic coordination, performance monitoring and analysis purposes.

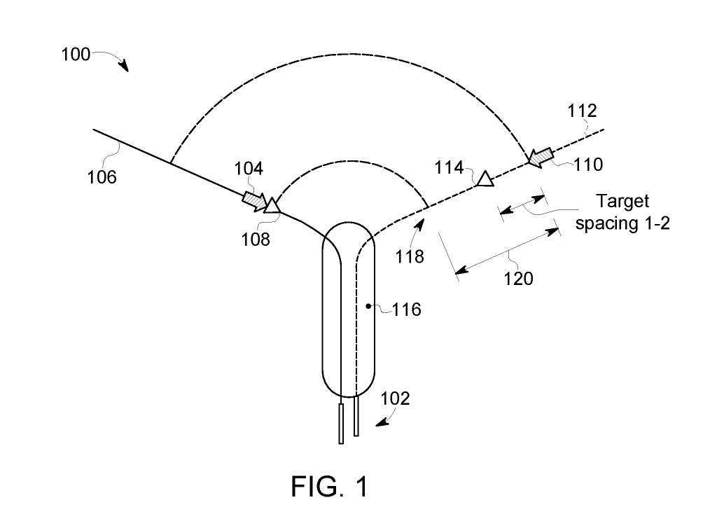

FIG. 1 is an illustrative depiction of an airspace 100, in a vicinity of an airport shown in the figure by a pair of parallel runways located generally at 102. FIG. 1 is illustrative of two different aircraft on two different flight paths. Here, Flight 1 (104), shown on flight path 106, is shown at a first meter point (“meter point 1”) 108. Flight 2 (110), shown on flight path 112, is shown approaching a second meter point (“meter point 2”) 114. In the present example, Flight 1 (104) is the leading flight and Flight 2 is the trailing flight (110). Flight 1 (104) and Flight 2 (110) are said to be related flights since they may fly over the same meter point or other navigation spacing concern to each other in a proximity of a target area (e.g., runway), for a period of time without limit to duration or when occurring. The locations of meter point 1 (108) and meter point 2 (114) are known, as well as a required minimum spacing for the two aircraft within airspace 100.

In one or more embodiments, from the approximation of the flight paths 106, 112, one or more conflict zones 116 may be identified. In one or more embodiments, a conflict zone 116 may be an area in which the relative timing or relative position between a pair of flights are to satisfy minimum safety requirements. The probability of at least one conflict zone concern for a pair of flights is an indication that the flight pair may be related. In one or more embodiments, separation buffers may be added to the required minimum distance at points along the reference flight path to achieve the desired probability that these minimum requirements may be satisfied without requiring tactical intervention of an air traffic controller during the arrival. The inventor notes that outside the conflict zone 116, minimum safety requirements may be automatically satisfied because of the large distance between Flight 1 (104) and Flight 2 (110).

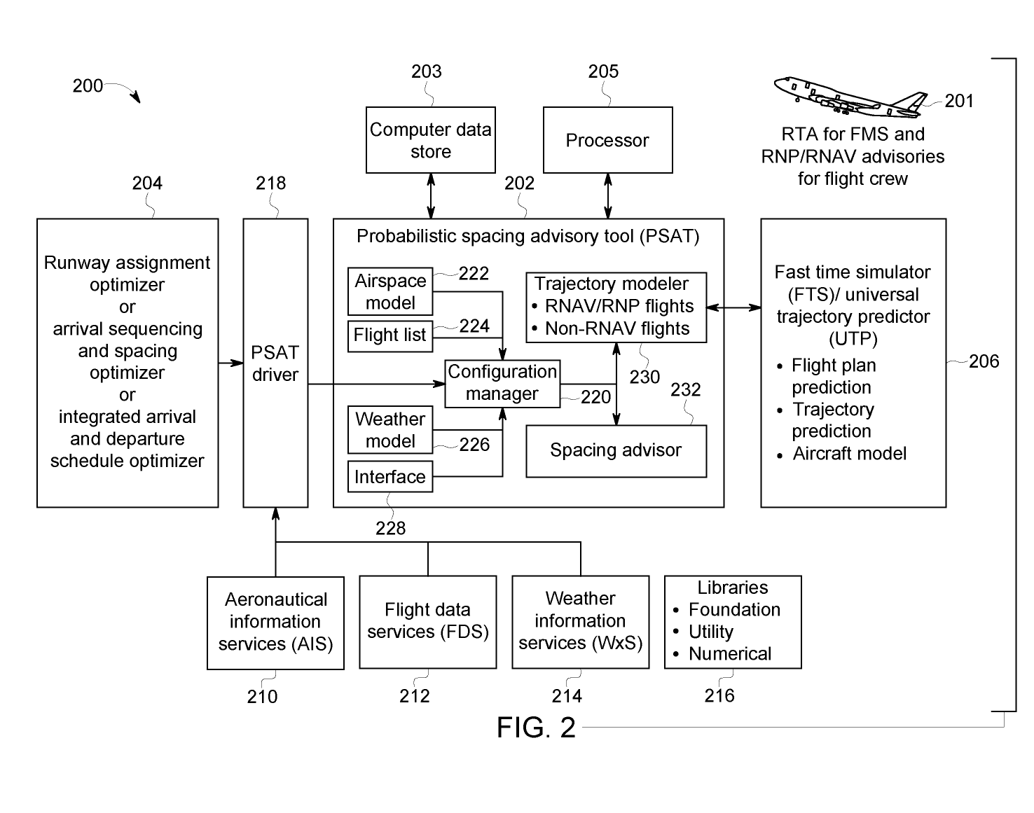

One or more embodiments may provide a mechanism for determining the required spacing at downstream locations of interest (i.e., meter points, at terminal airports, etc.). In the present example, a determination may be made regarding the spacing needed in the conflict zone 116 on the approach to the airport runways shown at 102. In one or more embodiments, back propagating the two flight paths 106, 112 to the first and second meter points 108, 114, desired (e.g., target) spacing may be determined by a spacing advisor module (232—FIG. 2). In one non-exhaustive example, the target spacing is the spacing to be met by Flight 2 (110) relative to Meter Point 2 (114) when Flight 1 (104) crosses Meter Point 1 (108). In one or more embodiments a determination is made to project the location of Flight 1 (104) onto flight path 112, as shown at 118. The equivalent point on flight path 112 for Flight 1 is calculated in some embodiments herein and is shown at 118. The distance or time interval (called headroom) between the equivalent point 118 and the calculated position of Flight 2 (110) when Flight 1 (104) crosses Meter Point 1 (108) gives an Internally Calculated Spacing 120. The distance or time interval (called headroom) between the Meter Point 2 (114) and the calculated position of Flight 2 (110) when Flight 1 (104) crosses Meter Point 1 (108) gives the Target Spacing 1-2 for Flight 2 (110) trailing Flight 1 (104). The Spacing Advisor Module 232 may determine a target spacing between Flight 1 and Flight 2 so that a minimum separation is maintained until and through the conflict zone 116 and terminal airport area based on the following relationship:

RTA2≥RTA1+Target Spacing 1-2,

where RTA1 (Required Time of Arrival) refers to the time for Flight 1 to arrive at meter point 1, RTA2 refers to the time for Flight 2 to arrive at meter point 2. In one or more embodiments, the spacing may be either in terms of distance or time (to traverse the distance). Given the location of meter point 2 (114) is known and the equivalent point of Flight 1 at meter point 1 on flight path 112 is calculated, the Spacing Advisor 232 (FIG. 2) may calculate the Target Spacing 1-2. In one or more embodiments, the system 200 (FIG. 2) may determine and provide RTAs to the aircraft and flight crew to operate flights. In one or more embodiments, the target spacing may be determined based, in part, on detailed, accurate, yet probabilistic trajectory predictions. A benefit of one or more embodiments may be that the generated target spacing at the meter point may ensure separation between the pair of flights with a desired probability during approach. It is noted that the spacing may be calculated using probabilities since the RTAs are calculated in advance to the actual completion of the flights to the downstream areas of interest (e.g., meter points and terminal airports).

In one or more embodiments, the target spacing between a pair of flights, if complied with, may provide a desired probability at which Flight 2 (110), the trailing flight, is expected to execute a RNP/RNAV approach without having to be interrupted for spacing concerns in, or before entering, the conflict zone 116. In one or more embodiments, if the trailing flight is a non-PBN aircraft, compliance with the target spacing may allow the aircraft to follow a nominal flight path, instead of being vectored to flow to an extended path to accommodate spacing concerns.

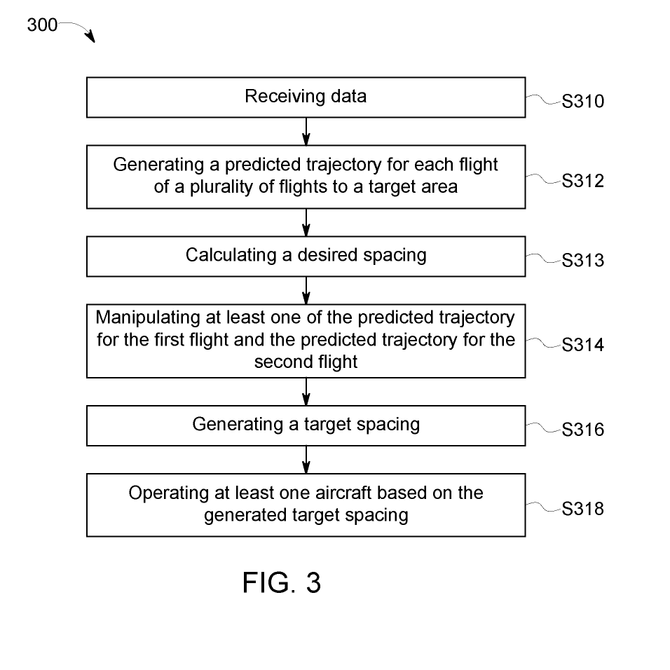

Turning to FIGS. 2 and 3, a system 200 and flow diagram of an example of operation of the system are provided according to some embodiments. In particular, FIG. 3 provides a flow diagram of a process 300, according to some embodiments. Process 300, and any other process described herein, may be performed using any suitable combination of hardware (e.g., circuit(s)), software or manual means. For example, a computer-readable storage medium may store thereon instructions that when executed by a machine result in performance according to any of the embodiments described herein. In one or more embodiments, the system 200 is conditioned to perform the process 300 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto. The flow chart(s) described herein do not imply a fixed order to the steps, and embodiments of the present invention may be practiced in any order that is practicable.

The system 200 may optimize a target spacing between pairs of PBN capable aircraft, as well as non-PBN capable aircraft, and combinations thereof, into one or more airports in a terminal area. Using the optimization provided by the system 200, the probability of successful (uninterrupted or without excessive vectoring) execution of RNP/RNAV arrival and/or approaches for PBN capable aircraft may be increased and the efficiency of approaches for both PBN capable aircraft and non-PBN aircraft may also be (simultaneously) improved. In some regards, the increase in the execution of RNP/RNAV arrivals and/or approaches and/or improved efficiencies in arrivals and/or approaches may be desired to, for example, reduce flight time, delay, along rack miles, fuel burn, noise impact to the community and emissions. Other benefits and advantages, such as but not limited to, enhanced situational awareness and safety may also be provided or facilitated by the system 200.

Initially at S310, data is received. In one or more embodiments, the system 200 includes a system, device, platform, service, or application that generates a probabilistic spacing for related aircraft. An example of such a system, device, platform, service, or application is shown, in general, at 202 in FIG. 2. In one or more embodiments, the system, device, platform, service, or application 202 will be referred to as a probabilistic spacing advisory tool (PSAT). In one or more embodiments, the PSAT 202 may be stored in computer hardware and may be executed to generate output data, which may be transmitted to other tools/systems.

In one or more embodiments, the system 200 may include one or more modules or services that receive data from, and send data to, the PSAT 202. For example, an optimizer 204 may receive data from the PSAT 202 to execute at least one optimization strategy. The optimizer 204 may be, for example, an arrival runway assignment optimizer, a standalone arrival sequence and spacing optimizer, or an integrated arrival and departure schedule optimizer. Other suitable optimizers may be used. As another example, the system 200 may include a trajectory engine 206. In one or more embodiments, the PSAT 202 may receive trajectory prediction data from the trajectory engine 206.

In one or more embodiments, the PSAT 202 may receive input data 208 from at least one of an aeronautical information service (AIS) module 210, a flight data series (FDS) module 212, and a weather services (WxS) module 214. In one or more embodiments, the MS module 210 may provide up-to-date data about airspace facilities to the PSAT 202. In one or more embodiments, the FDS module 212 may provide data about flights operating in the airspace to the PSAT 202. In one or more embodiments, the WxS module 214 may provide weather data for the trajectory prediction to the PSAT 202.

In one or more embodiments, the input data 208 may include aircraft equipage and capabilities (e.g., PBN capabilities including flight crew qualifications for flying PBN procedures); cleared flight plan or best available flight plan information, including speed schedule and preferred runway, if known; aircraft configuration information, including aircraft model type, engine type, aircraft weight, etc.; winds and temperature aloft and at the destination airport; and airport configuration, including runway direction and instrument landing system status. In one or more embodiments, the input data 208 may be provided by external sources (e.g., the ANSP or third party service providers), or by the aircraft, in part. In one or more embodiments, the input data 208 may be used by the PSAT 202 as is, or may be further processed by one or more models and/or modules. In one or more embodiments, when a particular data item is not available, internal databases and models of the PSAT 202 may be used to provide a best estimation. For example, the aircraft weight may be estimated locally by a function within the system. In one or more embodiments, the input data may be assigned a probabilistic property so that the derived solution may be stochastic in nature.

The system 200 may include one or more libraries 216 to support the PSAT 202 and any input data modules.

In one or more embodiments, the system 200 may include a driver 218. In one or more embodiments, the driver 218 may be a top level controller of all the processes in the system 200 or an intermediate interface to the modules that interact with the PSAT 202.

In one or more embodiments, the one or more modules/services that support the PSAT 202 may reside on the same computer hardware as the PSAT 202 or may reside on separate computer hardware that is electronically connected to the PSAT 202.

In one or more embodiments, the PSAT 202 may include a plurality of modules and models, including a configuration manager module 220, an airspace model 222, a flight list module 224, a weather model 226, an interface module 228, a trajectory modeler module 230 and a spacing advisor module 232.

In one or more embodiments, data may be stored in a data store 203, which may then be accessed for processing. In one or more embodiments, the data store 203 may comprise any combination of one or more of a hard disk drive, RAM (random access memory), ROM (read only memory), flash memory, etc. The data store 203 may store software that programs a processor 205 and the PSAT 202 and components thereof to perform functionality as described herein.

The processor 205 may, for example, be a conventional microprocessor, and may operate to control the overall functioning of the PSAT 202. In one or more embodiments, the processor 205 may be programmed with a continuous or logistical model of industrial processes. In one or more embodiments, the processor 205 may receive data for dynamically updating the models and generating a target spacing.

In one or more embodiments, the configuration manager module 220 may orchestrate the processes of the PSAT 202 to generate a target spacing. As will be described further below, the configuration manager module 220 may: implement updates to the airspace model 222, weather model 226, flight data for flights managed by the flight list 224, relevant trajectories, spacing matrix for the spacing advisor module 232 (e.g., generate target spacing, and assemble the target spacing data in a matrix (“spacing advisory matrix”)); maintain the flight list (e.g., verify flight status and consistency, and remove flights no longer in scope); publish flight plan predictions (e.g., publish trajectory updates so that they may propagate to other systems); publish spacing advisory matrix (e.g., publish the updated spacing matrix for use by the optimizer 204); perform internal bookkeeping and signal an external system of the progress and status of the PSAT 202.

In one or more embodiments, the configuration manager module 220 may start and initiate the processes executed in the PSAT 202 by claiming storage space 203 (e.g., in a computer hardware system), reading from an external storage (either in a local hardware system or in a remote hardware system that is electronically connected to the local hardware system), and passing the data to each process stored in the claimed space.

In one or more embodiments, the configuration manager module 220 may finalize and stop the processes executed by the PSAT 202 by retrieving appropriate information from each process already stored in the claimed space, writing this information to the external storage (either in the local hardware system or in remote hardware systems that are electronically connected to the local hardware system), and releasing previously claimed storage space.

In one or more embodiments, the configuration manager module 220 may maintain an internal clock synchronized with a wall clock. The configuration manager module 220 may, via the internal clock, track a shift in time and a scale in time, both of which may be flexibility configurable, and may include an option for the internal clock not to be synchronized with the wall clock. In one or more embodiments, the configuration manager module 220 may use the internal clock to provide time services to the PSAT processes in such a way that the PSAT 202 may be used to simulate the past, the future, and the current date at real-time, fast-time or slow-time.

Returning to process 300, in S312, a predicted trajectory for each flight of a plurality of flights to a target area is generated. In one or more embodiments, the configuration manager module 220 may execute the flight list module 224 to provide input to the trajectory modeler module 230 for generation of the predicted trajectory. In one or more embodiments, the flight list module 224 may include a flight list. The flight list may be a database of active flights destined to arrive at an airport within a terminal airspace. As used herein, an active flight is a flight that has already taken off from the origin airport, but has not yet landed outside an arrival time window. In one or more embodiments, the flight list module 224 may at least one of add a new flight to the flight list, update an individual flight in the flight list, remove an existing flight from the flight list, and query any parameters of a given flight. For each active flight, the flight list module 224 may maintain a plurality of parameters. For example, an internal unique object identification (IUID), a time stamp (e.g., date and time of the last update for a given flight, in the PSAT clock time, not necessarily the world wall clock time); status (e.g., indicating if the flight is new, updated or unchanged); flight plan (e.g., current flight plan following industry standards, such as International Civil Aviation Organization (ICAO) flight plan standards); long aircraft type (e.g., Optional long aircraft type designator. This may be used when the ICAO Aircraft Type Designator or the local ANSP aircraft type designator is not sufficient to specify the aircraft type, such as when “ZZZZ” is given, or when full length designator is needed to identify a specific aircraft type); aircraft state (e.g., current aircraft state, position, altitude, and other parameters); performance parameters (e.g., those to determine aircraft speed, and aircraft gross weight information that may be provided by the aircraft operator); weather profile (e.g., current weather profiles corresponding to the flight plan, as returned from the weather model 226); trajectory prediction (e.g., detailed 4D trajectory prediction, as returned from the trajectory modeler module 230); plan prediction (e.g., flight plan prediction may reflect predicted parameters at points on the flight plan, such that it may be shared with external systems, as needed); reference to the trajectory modeler module 230 (E.g., to track the trajectory model that may hold personality parameters of the aircraft for accurate trajectory prediction).

In one or more embodiments, execution of the flight list module 224 may execute a flight list maintenance process that keeps track of all of the active flights (i.e., has taken off, within an arrival time window) in a flight list. In one or more embodiments, the configuration manager module 220 may use the flight list module 224 to verify flight status and consistency by comparing information from different sources. In one or more embodiments, the configuration manger module 220 may decide which source to use for flight status information, should a conflict exist. In one or more embodiments, the flight list module 224 may decide which source to use for the flight status information, should a conflict exist. For example, if a flight has landed at a time outside an arrival time window, or if a flight has been diverted to a different terminal area that is outside the conflict zone 116, the flight may be removed from the internal flight list. In one or more embodiments, removal of the flight from the internal list may result in information regarding the flight being removed from an internal memory or may result in information regarding the flight being marked for removal in the internal memory such that other processes may not access the information.

In one or more embodiments, the configuration manager module 220 may execute a trajectory update process to determine whether to generate an updated trajectory prediction for each flight in the flight list via the trajectory modeler module 230. As used herein, the update may be generated when a change in a parameter has exceeded a range either defined deterministically or probabilistically. In one or more embodiments, in making the determination, the configuration manager module 220 may consider one or more parameters. The parameters may include, for example, an indication that a flight is new, an update in flight data, an update in the airspace that impacts a given flight, an update in weather that impacts the given flight, and that the flight must be in a time window that is defined by a range of estimated crossing time at one or more reference point(s) in the airspace. Other suitable parameters may be used.

In one or more embodiments, the trajectory update process may verify if the trajectory modeler module 230 is able to perform a trajectory prediction. In one or more embodiments, if the trajectory modeler module 230 is able to perform the trajectory prediction, execution of the trajectory update process may cause the trajectory modeler module 230 to generate a predicted trajectory for each flight. If the trajectory modeler module 230 is unable to perform the trajectory prediction, the trajectory modeler module 230 may be re-initialized. In one or more embodiments, the trajectory update process may also verify if the aircraft is PBN capable, so that either an RNP/RNAV prediction or a conventional prediction may be executed.

In one or more embodiments, as part of the trajectory update process the configuration modeler module 220 may request data from the airspace model 222 as input to the trajectory modeler module 230. In particular the airspace model 222 may provide data indicative of one of a single flight path or a plurality of flight paths. In one or more embodiments, a flight plan reflecting what the aircraft is intended to fly, may be sent to the airspace model 222 as input for the airspace model to determine which flight path(s) to return. In some instances, an exact flight path maybe found that matches what is in a flight plan; while in other instances, an exact flight path may not be found (e.g., due to airport configuration changes), in which case a “best match” path may be returned, as described further below. In one or more embodiments, the flight path(s) may be represented by reference flight path(s). In one or more embodiments, in response to the request, the airspace model 222 may return, for each flight path, a sequence of spacing values given at various points along the flight path. The sequence of spacing values may provide a basic reference for the spacing advisor module 232 to determine the target spacing, as further described below.

In one or more embodiments, the airspace model 222 may be a model of a destination terminal area. The airspace model 222 may model aerodromes, arrival meter points, arrivals, radar sites, reference arrival paths, and arrival spacing vectors.

In one or more embodiments, aerodromes may include airports in the terminal area and runways at the airport, including the location, orientation, and distance between runways.

In one or more embodiments arrival meter points may be points near the boundary of the terminal airspace where the arrival traffic flow may be regulated into the terminal airspace. In one or more embodiments, an arrival meter point may be any selected point. In one or more embodiments, the arrival meter point may be varied to achieve the goals of different control strategies to balance a robustness of flow control at the runways, and the expected benefits of the flow control, such that this may be a control mechanism.

In one or more embodiments arrivals may be arrival procedures for airports in the terminal area, including if an arrival is RNP/RNAV or non-RNAV.

In one or more embodiments, radar site may be the air traffic control radar site location. The location may be used to determine a radar separation minimum at any point in the airspace.

One or more reference arrival paths may be a nominal path that identifies a most representative path from an arrival meter point to a runway. In one or more embodiments, a complete reference arrival path may connect the en-route segment of the flight, a potential candidate arrival meter point, an arrival procedure, an initial approach connection sequence, an initial approach procedure, an instrument approach connection sequence, an instrument approach procedure, and an approach runway. In one or more embodiments, reference arrival path may be used as a common reference for flights arriving via the same arrival meter point and to the same runway. In one or more embodiments, by using the reference arrival path, different flights may be compared in terms of their progress, their relative position and the spacing of concern, even if the actual flight paths of the different flights deviate from each other.

In one or more embodiments, the arrival spacing vector may be a sequence of spacing values along a reference arrival flight path. There may be default values stored in the arrival spacing vector, and in their internal form, these default values may be radar separation minima along the reference flight path, given a plurality of points. The number of points and the location of such points and the distance between them may be selected such that all possible interactions between different reference flight paths may be captured by the arrival spacing sequence vector.

In one or more embodiments, the airspace model 222 may include a method to return a reference arrival path. The airspace model 222 may receive the current time, the flight plan, all the available information of a flight plan, and aircraft PBN capabilities as input. The airspace model 222 may use the input to find the best match arrival meter point, an arrival procedure, an initial approach connection sequence, an initial approach procedure, an instrument approach connection sequence, an instrument approach procedure, and an approach runway. As used herein, “best match” means an exact find of an item, or an item that is close to the corresponding item in the flight plan. For example, if an item is not available (e.g., an initial approach procedure for a particular airport), it may be omitted from data sent to the trajectory modeler module 230, but the path would still be connected by the connection sequence for the next item downstream (e.g., the instrument approach connection). As used herein, “best match” may also mean a plurality of possible candidates. For example, if any of three parallel runways may be used by a flight, then the best match may be all three candidate runways. The airspace model 222 may return all candidate reference flight paths for the request. The inventor notes that the availability of runways, for example, may be impacted by the meteorological conditions.

In one or more embodiments, the airspace model 222 may include a method to return an arrival spacing vector for a pair of flights. The airspace model 222 may receive the current time, the reference flight paths for a pair of flights, and the aircraft model types for the pair of flights as input. The initial arrival spacing vector may be the default arrival spacing vector for the reference flight path of the leading flight. The default arrival spacing vector may first be adjusted based on a spatial relationship of the two reference flight paths. Then any points outside the conflict zone 116 may be removed (e.g., the removed points may not be used in determining the target spacing). In one or more embodiments, a point may be removed by setting the spacing value to negative infinity, or by removing the point from the vector as if it never existed. In one or more embodiments, the arrival spacing vector may then be modified by a wake turbulence separation, based on the aircraft model types, the location, orientation, and distance of the runways for the pair of flights. In one or more embodiments, this modification may include either an increase of the separation at a point (e.g., a heavy aircraft is followed by a small aircraft directly behind it) or a decrease of the separation at a point (e.g., between parallel runways separated by a large distance). In one or more embodiments, these modifications may be implemented based on regulations effective at the airport at the time. In one or more embodiments, any other type of adjustments specific to an airspace facility at the time of expected landing will also be considered. For example, runway visual conditions, other meteorological conditions, and runway occupation time may be considered. In the example of meteorological conditions, a reduced arrival rate for a given runway or for a pair of parallel runways may be considered. In one or more embodiments, the airspace model 222 may then return the arrival spacing vector.

In one or more embodiments, as part of the trajectory update process and execution of the trajectory modeler module 230, the configuration manager module 220 may request data from the weather model 226 as input to the trajectory modeler module 230. In particular, the weather module 226 may provide data indicative of corresponding weather profiles (e.g., winds aloft and temperature), arrival procedures, approach procedure availability, and arrival rate parameters for each flight path. In one or more embodiments, the flight path returned from the airspace model 222 may be sent to the weather model 226 to request weather (e.g., winds, temperature) data. In a 4D airspace, weather data is specific for a given flight path.

In one or more embodiments, the weather model 226 may be a model of the meteorological conditions within the destination terminal area (e.g., airspace about 40 nautical miles around an airport or a group of airports). In one or more embodiments, the weather model 226 may model altimeter settings (e.g., information to be uplinked to the aircraft to adjust the barometric altimeter); surface winds and temperature (e.g., may impact the runway usage); sky cover and ceiling (e.g., may impact the approach minimums, and limitations on arrival rates); visibility (e.g., may impact arrival rates); runway surface conditions (e.g., may impact runway usage); winds and temperature aloft (e.g., may influence aircraft trajectories); and convective weather (e.g., may impact arrival procedure, approach procedure and runway availability).

In one or more embodiments the weather model 226 may return runway, arrival procedure, and approach procedure availability. The availability may provide information on possible runways, arrival procedures, and approach procedures available for use at the time of expected arrival and landing times.

In one or more embodiments, the weather model 226 may return parameters that match the airspace criteria for predicting arrival rates. Some examples of returned parameters may include conditions of flight rules (e.g., visual, instrument or marginal conditions). Other suitable returned parameters may be used.

In one or more embodiments, the weather model 226 may return a weather profile for a flight expected to fly a reference arrival path. In one or more embodiments, the weather profile may include a profile of winds and temperature aloft for the given flight path, with associated altitude and locations. The weather profile may also include surface weather conditions (e.g., surface winds and temperature), which may influence a flap configuration settings of the aircraft, and consequently the final approach segment of the trajectory.

In one or more embodiments, the trajectory modeler module 230 may hold a probability of personality parameters for a given aircraft that is performing an active flight. In one or more embodiments, personality parameters may include aircraft weight, fuel on board, specific configurations and flight parameters that may include aircraft performance and trajectory, but may not be fully identifiable by the aircraft model type information included in the flight list, for example.

In one or more embodiments, to generate detailed, accurate trajectories, the trajectory modeler module 230 may at least one of call a separate deterministic trajectory prediction tool, such as the Fast Time Simulator (FTS)/Universal Trajectory Predictor (UTP) 206, may include internal methods, and may predict probabilistic trajectories. When predicting probabilistic trajectories, the trajectory modeler module 230 may treat RNP/RNAV trajectories different from non-RNAV trajectories.

In one or more embodiments, an uninterrupted RNP/RNAV trajectory may follow a prescribed path, which may be the basis of a reference arrival path. Uncertainties in the environment and lack of performance parameters may be responsible, in part, for the variation of the RNP/RNAV trajectory. The variation, with respect to spacing, may be represented by an uncertainty of predicted time of arrival at any point on the flight path. The inventor notes a novel feature of one or more embodiments is the conversion of this uncertainty into a probabilistic separation buffer along the arrival path.

The probabilistic separation buffer may not be constant, but instead may vary along the arrival path. For example, the closer the separation buffer gets to the runway threshold, the larger the buffer may be. In one or more embodiments, the separation buffer may be set to zero at a point the leading fight crosses its own arrival meter point since the arrival meter point is where the target spacing is calculated. In one or more embodiments, the separation buffer may be impacted by the availability and the reliability of the input data. For example, if aircraft weight is not available, it may be estimated. However, the estimation and inherent uncertainties with estimation may cause the separation buffer to increase. Another example may be the reliability of winds and temperature forecasts. Yet, another example may be a probability associated with pilot actions in managing aircraft speed via air speed brakes, flaps, or other means. In one or more embodiments, the value of the separation buffer may be related to a desired probability that the arrival and approach may be executed without air traffic controller intervention. For example, if the desired probability is 50%, then for an unbiased prediction, the separation buffer should be zero. In one or more embodiments, the growth of the separation buffer may not be linear. For example, a 100% desired probability may result in an excessive separation buffer. An excessive separation buffer may be undesirable, as a larger buffer means increased target spacing, which may mean fewer aircraft may land in a given time period, which may consequently cause excessive flight delays. In one or more embodiments, a tradeoff to excessive separation buffer may be found experimentally via simulation or real world data. For example, it may be found that an acceptable separation buffer is found with a 75% desired probability.

In one or more embodiments, if the Required Time of Arrival capability is input to the PSAT 202 during descent and approach, the trajectory may become controllable during the approach. In one or more embodiments, the separation buffer may be further reduced (e.g., given a five second equivalent buffer for well-equipped aircraft). As a property of the predicted trajectory, the trajectory modeler module 230 may provide properties of factors that may be interpreted as separation buffers based on the desired probability by providing parameters of a distribution (e.g., normal distribution or a beta distribution), in one or more embodiments. The parameters may vary based on a distance relative to the arrival meter point. In another embodiment, the desired probability may be provided as an input parameter to the trajectory modeler module 230 for the module 230 to return the separation buffer directly.

In embodiments where the desired probability is an input parameter to the trajectory modeler module 230, a non-RNAV trajectory may follow a conventional procedure, but not a comprehensively prescribed path. In these instances, an air traffic controller may provide a vector command to the aircraft during the aircraft approach. The trajectory modeler module 230 may call the trajectory predictor component 206 to generate a nominal trajectory based on the reference arrival path (e.g., prescribed path followed by normal flight operations). The trajectory modeler module 230 may generate a “slow-man” and a “faster-man” trajectory to reflect possible range of the non-RNAV trajectories. In this case, the range may be related to the desired probability. For example, a low desired probability may allow a non-RNAV flight to be less constrained, thus less vectored and able to more closely follow the reference arrival path (which resembles RNAV paths). Conversely, a high desired probability may mean the RNP/RNAV flight will be more rigorously protected, thus more vectored non-RNAV trajectories may be used. A user may introduce an additional trade-off objective in the optimizer 204 to consider how much within the given range the non-RNAV flight may be adjusted to achieve system level performance. In one or more embodiments, the actual range may be obtained by quantitatively analyzing trajectories of non-RNAV trajectories with respect to the reference arrival path.

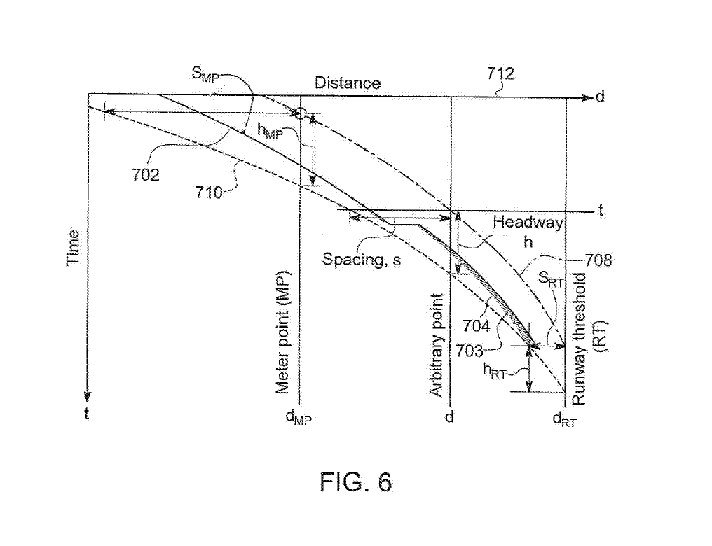

Turning back to process 300, a desired spacing 703 for at least one of the points along a reference flight path is calculated in S313. In one or more embodiments, separation minima, wake vertex requirements, flow rate considerations, and calculation of a plurality of separation buffers for at least one of the points along the reference flight path may be included as input in the calculation of the desired spacing. As shown in FIG. 6, the desired spacing 703 may be the left boundary of the separation buffer 704, described below. In one or more embodiments, the desired spacing 703 may be provided as a desired spacing vector that may provide desired spacing values at a number of points along the reference flight path (e.g., at 1, 5, 10, 15, 20 nautical miles to the runway threshold). In one or more embodiments, the desired spacing 703 may be achieved, as described below, to have a good trade-off between spacing and flow efficiency (e.g., less delay).

Then in S314, at least one of the predicted trajectory for the first flight and the predicted trajectory for the second flight is manipulated based on the desired spacing. For example, at least one predicted trajectory may be shifted along a time axis to achieve the calculated desired spacing. Then in S316, a target spacing is generated. In one or more embodiments, the target spacing may be generated based on the received data, the generated predicted trajectory, and the manipulation of the predicted trajectory. In one or more embodiments, target spacing may be a single number at the meter point. When traffic flow is managed, the target spacing at the meter point is metered. If everything proceeds as planned, the air traffic controller may just watch without intervention and the aircraft will have a ride as planned. If, for some reason, the spacing becomes an issue at some point, the air traffic controller may intervene by issuing a vector command (e.g., turning left for a few miles and then returning to the reference path). The vector command may stretch the actual path and thus delay the trailing flight, so that the spacing may be maintained.

In one or more embodiments, the spacing advisory module 232 may receive the current time, probabilistic trajectory predictions from the trajectory modeler module 230, the desired probability of uninterrupted RNP/RNAV operations, the arrival spacing vector from the airspace model 222, arrival meter points and reference arrival paths for a pair of flights via the configuration manager module 220 to generate target spacing for the pair of flights.

In one or more embodiments, for flights along a given path, the movement of the aircraft may be expressed by the position of the aircraft on the flight path d as a function of time t, and vice versa. The one-dimensional functional expression of the trajectory may be expressed as follows:

$$\{ \begin{matrix}d = f ( t ) \\ t = g ( d )\end{matrix}$$

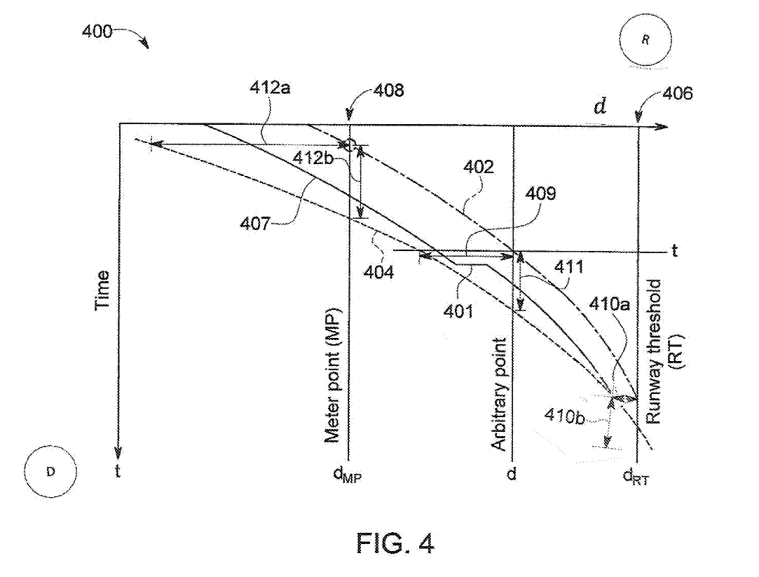

Turning to FIG. 4, a time-distance graphical representation of trajectories along a given flight path 400 is provided according to embodiments. As shown herein, the horizontal axis represents distance along the flight path, with the positive sense in the direction of the flight pointing towards R. The vertical axis represents time, with the positive sense pointing towards D. This is different from conventional time-space diagrams, where the horizontal axis represents time and the vertical axis represents distance. The inventor notes the graphical representation provided herein may be more easily understood. In particular, FIG. 4 illustrates trajectories of a pair of consecutive flights (i.e. leading flight 402 and trailing flight 404). Along the distance axis, a plurality of airspace features may be identified, such as a runway threshold 406 and a meter point 408. At any moment t, a difference between the distances along the path for the two flights may be the spacing s (409). The separation minima 407 indicates a legally required distance to be maintained between aircraft. In a more general case, the separation minima 407 may be given by the spacing vector discussed earlier. The step 401 shown in the separation minima 407 illustrates a change of the separation minimum from 3 nautical miles to 5 nautical miles when the line distance from the radar site becomes greater than a threshold (e.g., 40 nautical miles. Other suitable distance may be used.). At any point d along the path, the difference between the crossing times for the two flights is the head time h (411). As shown herein, spacing and headway at a runway threshold 410a, b and a meter point 412a, b are shown herein. If consistent constraints are applied to the trajectories, via the spacing advisory module 232, then spacing and headway at different points along the path may be correlated, which may be the basis for spacing analysis. As shown in the non-exhaustive example herein, the spacing at the meter point S_{MP} ensures that the separation minima or the spacing values in the spacing vector are satisfied for the duration of the flight from the meter point to the runway threshold, all without adding any buffer. This is because there is at least one point at which the trajectory of the trailing flight has touched the separation minima but not violated the separation minima from the leading flight. Such a spacing S_{MP} may eliminate the need of air traffic controller intervention in the terminal area.

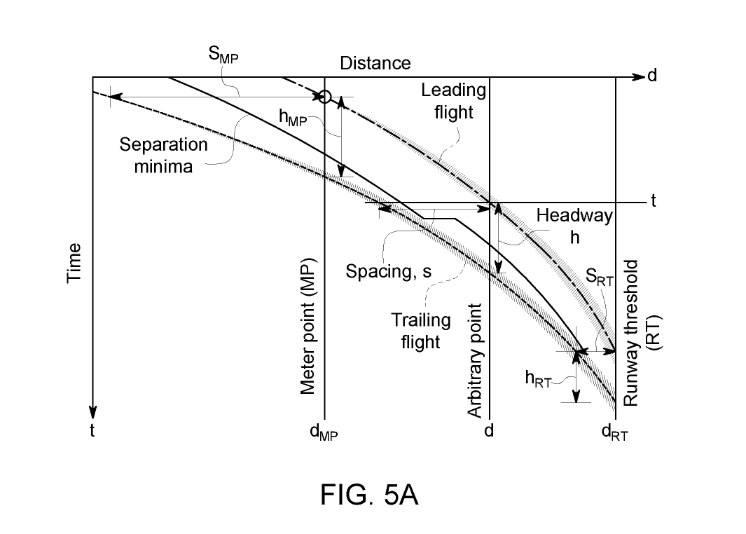

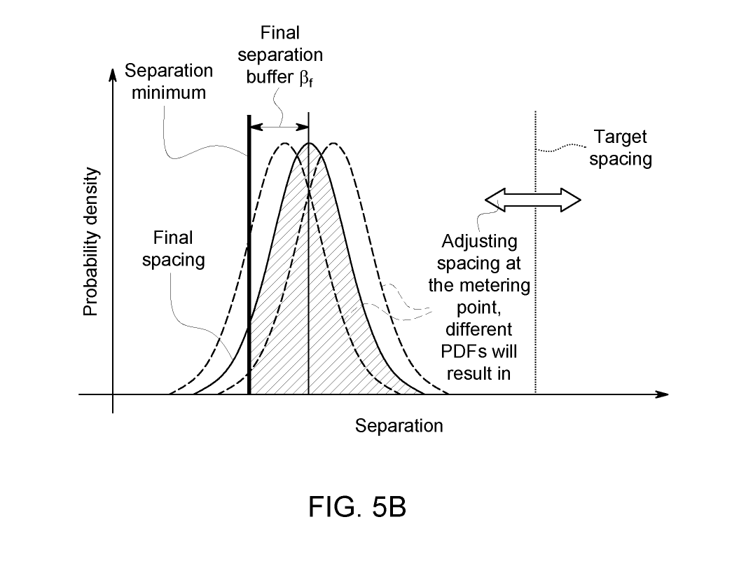

Turning to FIG. 5A, due to various uncertainty factors, the trajectory for the leading flight and the trajectory for the trailing flight will not be deterministic as shown in FIG. 4. Rather, trajectory variation would be observed, as indicated by the shaded areas around the trajectory for the leading flight and the trajectory for the trailing flight. This means, the exact trajectory cannot be known at the time when the trailing flight crosses the meter point. Thus, a separation buffer may be included in the spacing at the meter point S_{MP} to ensure that the separation minima are satisfied for the duration of the flight from the meter point to the runway threshold. The desired probability concept discussed earlier was introduced in prior studies (Ren, Liling, “Modeling and Managing Separation for Noise Abatement Arrival Procedures,” Sc.D. Thesis, MIT, Cambridge, Mass., February 2007) (hereinafter “Ren study”) to provide less than a 100% guarantee, which will not eliminate air traffic controller intervention completely—doing so will add an excessively large separation buffer. Instead, the desired probability concept seeks to provide a tradeoff to maintain the probability of not requiring air traffic controller intervention to a desired level, i.e., at the desired probability. The inventor notes that one of the benefits of embodiments is the ability to manage merging traffic flow to different runways, while the Ren study described only managing traffic on the same path to the same runway. Another benefit of embodiments noted by the inventor is the conversion of trajectory uncertainties into separation buffers for a probability of points along the reference flight path, and use of the resulting desired spacing to efficiently determine the target spacing, while the Ren study only discussed a separation buffer at the runway. The inventor further notes another benefit of embodiments is the use of the separation buffer in managing the flow, while the Ren study only calculated the separation buffer after a traffic flow was determined.

FIG. 5B (inset graph) illustrates the definition of the separation buffer at the final approach fix or the runway threshold, as described in the prior Ren study. A process was employed to calculate a large ensemble of trajectories for both the leading flight and the trailing flight, and then the separation buffer, from which the target spacing can be derived for the common meter point. This process provided in the Ren study is computationally intensive and it not meant to be used in real time.

Turning to FIG. 6, for in-trail flights on a same flight path, the determination of target spacing, via the spacing advisor module 232, is provided, according to embodiments. In one or more embodiments, to the left of separation minima (or otherwise referred to as the spacing vector) 702, the shaded area may denote an application of the separation buffer 704. In one or more embodiments, the spacing advisor module 232 may translate trajectory uncertainties for both a leading flight 708 and a trailing flight 710 along their respective flight paths into the separation buffer 704 along a reference flight path 712. The spacing vector with the applied separation buffer, shown as the left boundary of the shaded area, may provide a desired spacing along the flight path. While the reference flight path is a 3D path in the airspace, in this figure, the reference flight path is compressed into a 1D line. In one or more embodiments, the separation minima are given at points along the reference flight path 712. The inventor notes that this translation makes the calculation of the target spacing extremely efficient. One or more embodiments provide for the obtainment of the separation buffer and desired spacing first, and then use a single analysis run to determine the target spacing, thus it is more efficient, more dynamic, and more accurate because it considers dynamic information specific to the aircraft pair. In the Ren study, for example, you need to simulate each of the flights' trajectory hundreds of times or thousands of times, then obtain the target spacing through a separation analysis methodology. In one or more embodiments, on the other hand, trajectory uncertainties are translated into a separation buffer that is applied to the spacing vector to calculate desired spacing vector, which may not need to be calculated every time a trajectory needs to be predicted (or updated). In one or more embodiments, the trajectory may only need to be predicted once, thus making the process suitable for real-time applications. Previously, trajectories need to be predicted hundreds or thousands of times and used on predetermined flight paths off-line. Then, in conventional scenarios, a look up table is created and used in real time, thus making it less accurate and less reliable when the nominal wind profiles change, or when new flight paths are returned by the airspace model.

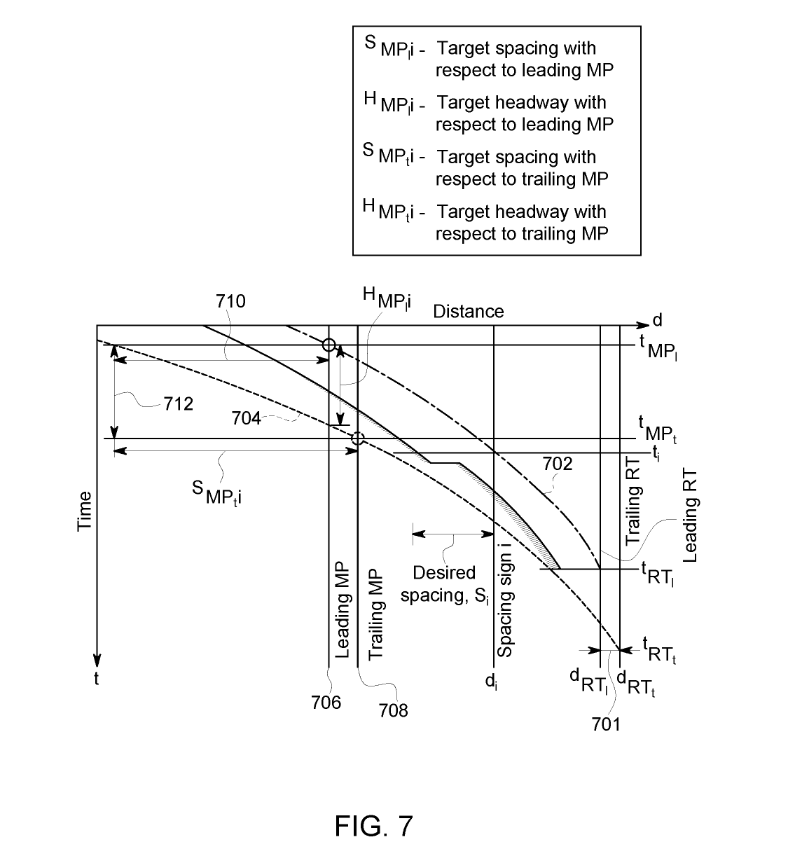

Turning to FIG. 7, for merging arrival flows from two different directions going to the same runway, or for arrival flows from two different directions merging, and then going to two different runways, where there is no instantaneous conflict between flights on two separate flight paths until they merge (e.g., until they enter into the conflict zone 116). In this instance, regardless of the relative spacing, the separation minima may be automatically satisfied before the pair of flights enters the conflict zone 116. Thus, flights on two separate merging paths may be treated as if they are on the same flight path, but without the need to enforce separation minima until they enter the conflict zone 116. In this figure, it is assumed that a common reference frame may be defined so that the two trajectories along two reference flight paths may be laid out in the same time-distance diagram. For the example provided herein, all parameters are given in this common reference frame. In the example provided herein, the two flights paths are assumed to be going to two different runways (e.g., two parallel runways). A runway threshold offset parameter δ_{RT} (701) may be used to denote the longitudinal difference between locations of the two runway thresholds. As shown herein, each flight path 702, 704 has its own meter point, as denoted by d_{MP}_{ₗ} 706 for the leading flight 702 and d_{MP}_{ₜ} 708 for the trailing flight 704. In one or more embodiments, the spacing advisor module 232 may determine the target spacing S_{MP}_{ₜ} 710 and target headway H_{MP}_{ₜ} 712 both with respect to the meter point for the trailing flight 704. As an intermediate step, a target spacing S_{MP}_{ₗ} (not shown) and a target headway H_{MP}_{ₗ} (not shown) with respect to the meter point for the leading flight 702 may be determined first. These two targets may indicate how far behind the trailing flight should be relative to the meter point of the leading flight when the leading flight crosses its meter point, should the trailing flight be on the same reference flight path as the leading flight (but it is actually on a separate flight path, as described see below). The latter two targets however do not have much practical use as the trailing flight is on a separate path that is not directly related to the meter point for the leading flight.

Continuing with FIG. 7, spacing sign i in the desired spacing vector provides a desired spacing Sᵢ at location dᵢ that may be satisfied without adding any additional buffer to Sᵢ. With respect to the manipulation described above, in S314, For example, in one or more embodiments, the spacing advisory module 232 may satisfy the desired spacing Sᵢ without adding any additional buffer by shifting the trailing trajectory along the time axis by δtᵢ such that

gₜ(dᵢ−Sᵢ)+δtᵢ=tᵢ, where tᵢ=gₗ(dᵢ)

tᵢ may represent the shifted trailing trajectory that satisfies desired spacing Sᵢ. This may be the same requirement as in the case of two flights following the same flight path, except that the two trajectories may be represented in a common reference frame, and that the conflict zone is smaller.

Denoting the shifted trailing trajectory by g_{t,i}( ) and f_{t,i}( ), it may be derived, in one or more embodiments, that

$$\{ \begin{matrix}d = {f}_{t , i} ( t ) = {f}_{t} ( t - δ {t}_{i} ) \\ t = {g}_{t , i} ( d ) = {g}_{t} ( d ) + δ {t}_{i}\end{matrix} , where δ {t}_{i} = {g}_{l} ( {d}_{i} ) - {g}_{t} ( {d}_{i} - {S}_{i} )$$

With a satisfactory trailing trajectory given by the immediately preceding equation, given relative to the meter point for the leading trajectory, the target spacing S_{MP}_{ₗ}_{,i} and target headway H_{MP}_{ₗ}_{,i} corresponding to desired spacing Sᵢ may be determined as

$$\{ \begin{matrix}{S}_{{MP}_{l} , i} = {d}_{{MP}_{l}} - {f}_{t , i} ( {t}_{{MP}_{l}} ) \\ {H}_{{MP}_{l} , i} = {g}_{t , i} ( {d}_{{MP}_{l}} ) - {t}_{{MP}_{l}}\end{matrix} , where {t}_{{MP}_{l}} = {g}_{l} ( {d}_{{MP}_{l}} )$$

Relative to the meter point for the trailing trajectory, the target spacing S_{MP}_{ₜ}_{,i} (710) and target headway H_{MP}_{ₜ}_{,i} (712) corresponding to desired spacing Sᵢ maybe determined as:

$$\{ \begin{matrix}{S}_{{MP}_{t} , i} = {d}_{{MP}_{t}} - {f}_{t , i} ( {t}_{{MP}_{l}} ) \\ {H}_{{MP}_{t} , i} = {g}_{t , i} ( {d}_{{MP}_{t}} ) - {t}_{{MP}_{l}}\end{matrix} , where {t}_{{MP}_{l}} = {g}_{l} ( {d}_{{MP}_{l}} )$$

In one or more embodiments, the target spacing S_{MP}_{ₜ}_{,i} (710) and the target headway H_{MP}_{ₜ}_{,i} (712) at the meter point satisfies all given desired spacing without adding any additional buffers. With the target spacing and target headway corresponding to individual desired spacing Sᵢ, i=1 n determined, a final target spacing S_{MP}_{ₜ} and the target headway H_{MP}_{ₜ} is

$$\{ \begin{matrix}{S}_{{MP}_{t}} = max ( {S}_{{MP}_{t} , 1} , … {S}_{{MP}_{t} , i} , … {S}_{{MP}_{t} , n} ) \\ {H}_{{MP}_{t}} = max ( {H}_{{MP}_{t} 1} , … {H}_{{MP}_{t} , i} , … {H}_{{MP}_{t} , n} )\end{matrix}$$

It should be noted that if no holding pattern is applied as a parameter to the trajectory, the same most constraining desired spacing, i.e., the one that yields the maximum value among all S_{MP}_{ₜ}_{,i}, will determine both the target spacing and the target headway. Otherwise, the target spacing and the target headway may be determined by the desired spacing at two different spacing signs respectively.

The solution to the problem of target spacing and target headway disclosed above is derived in a common reference frame for both the leading and trailing flights. The inventor notes that it is not trivial to derive the solution in a common reference frame. The reason is simple. A trajectory is often given in a reference frame defined for its corresponding flight path. While the same time reference (clock) may be used by all trajectories, it is normally not the case for the distance along different flight paths. For efficient and consistent calculations, the solution may be translated into the reference frames used by individual flight paths (i.e., the leading flight path and the trailing flight path). Using a superscript to denote the reference frame for the corresponding flight path, i.e. l for the leading flight path and t for the trailing flight path, trajectories in their own flight path frames may be expressed as:

$$\{ \begin{matrix}{d}^{l} = {f}_{l}^{l} ( {t}^{l} ) \\ {t}^{l} = {g}_{l}^{l} ( {d}^{l} )\end{matrix} \\ \{ \begin{matrix}{d}^{t} = {f}_{t}^{t} ( {t}^{t} ) \\ {t}^{t} = {g}_{t}^{t} ( {d}^{t} )\end{matrix}$$

In a more general case, the translation between the flight path frames and a common frame may be expressed by:

$$\{ \begin{matrix}d = {d}^{l} + Δ {d}^{l} \\ t = {t}^{l} + Δ {t}^{l}\end{matrix} \\ \{ \begin{matrix}d = {d}^{t} + Δ {d}^{t} \\ t = {t}^{t} + Δ {t}^{t}\end{matrix}$$

Then, the target spacing and target headway corresponding to a desired spacing Sᵢ may be calculated using trajectories given in their own flight path frame as:

$$\{ \begin{matrix}{S}_{{MP}_{t} , i} = function of {d}_{i}^{l} , {S}_{i} , {d}_{{RT}_{t}}^{t} , {d}_{{RT}_{l}}^{l} , {δ}_{RT} , {d}_{{MP}_{l}}^{l} , {d}_{{MP}_{t}}^{t} \\ {H}_{{MP}_{t} , i} = function of {d}_{i}^{l} , {S}_{i} , {d}_{{RT}_{t}}^{t} , {d}_{{RT}_{l}}^{l} , {δ}_{RT} , {d}_{{MP}_{l}}^{l} , {d}_{{MP}_{t}}^{t}\end{matrix}$$

In one or more embodiments, the target spacing and target headway may be calculated independent of a common reference frame for merging traffic.

Then in S318, the target spacing may be distributed to other systems 201, for example, flight crews, ANSP and aircraft operations control centers to operate aircraft in view of the generated target spacing.

In one or more embodiments, prior to selection of a final target spacing and target headway, and the subsequent manipulation of the predicted trajectory, the configuration manager module 220 may execute a spacing advisory matrix generation process via execution of the spacing advisor module 232. In one or more embodiments, the spacing advisory matrix may be generated by permuting all possible flight pairs for a given time window. For example, for Flight 1 and Flight 2, two flight pairs may be generated—1. Flight 1 as the leading flight and Flight 2 as the trailing flight; and 2. Flight 2 as the leading flight and Flight 1 as the trailing flight. This permutation may enable a change of flight sequence to be considered by the optimizer 204. In one or more embodiments, the flight pairs may be filtered to include related flight pairs, or based on a probability of conflict zone concern between a pair. In one or more embodiments, the probability of conflict zone concern may refer to if the estimated time of crossing at a reference point in the airspace (e.g., arrival meter point, the runway threshold, intersection of two crossing runways, or the airport landing time related to airport surface operation concerns) or the estimated time to traverse a small block of airspace (e.g., a block defined by separation minima, e.g., 3 nautical miles laterally and 1,000 feet vertically, closely spaced parallel runways. Other airspace volume structure and characteristic lengths may be used) is close enough so that the probability of no other flights landing between them is greater than a threshold. For example, if there is definitely going to be another flight C landing between flight A and flight B, there may not be a conflict zone between flight A and flight B because flight A will be directly followed by flight C, not flight B. The potential conflict would be between flight A and flight C, not flight B. However, one or more embodiments provide that if flights A, B and C are close to each other, then flights A and B, flights B and C, and flights C and A may all be a conflict concern. As such, the PSAT 202 may calculate target spacing for all the possible combinations or pairs among them so that all possibilities may be considered to find the most reasonable solution via optimization. In one or more embodiments, if two flights are procedurally separated (e.g., they fly over the same point but at different altitudes that meet the vertical separation minimum), they may not be considered a concern to each other. In one or more embodiments, filtering the flight pairs may reduce the number of flight pairs for which a target spacing may be determined, and may thereby reduce the size of the spacing advisory matrix. The inventor notes that a smaller spacing advisory matrix may use less storage and may save in communication time, reduce the complexity of the optimization, making the system more efficient.

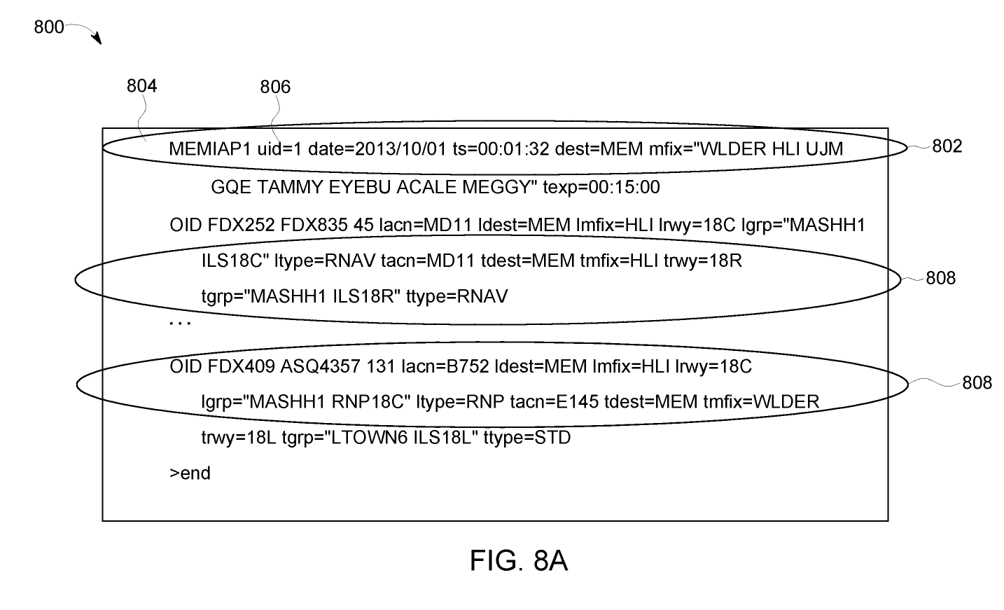

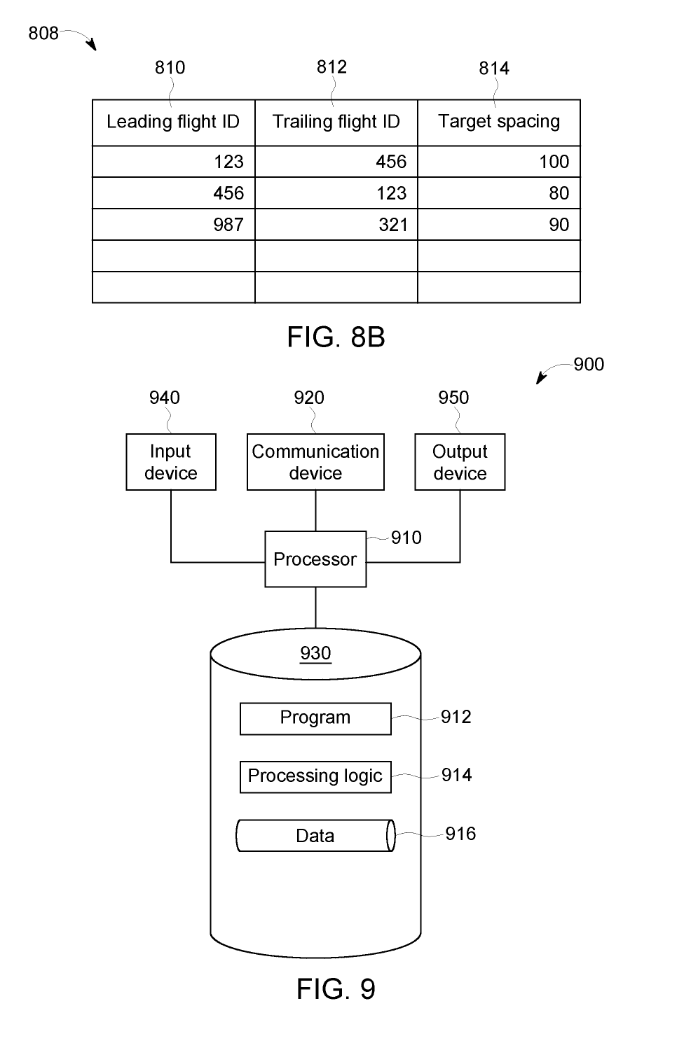

In one or more embodiments, the spacing advisor module 232 may determine a probabilistic target spacing for each filtered flight pair. The target spacing for the flight pairs may then be assembled into a spacing matrix 800 (FIG. 8A).

In one or more embodiments, the spacing matrix 800 may include a header record 802. The header record 802 may contain a target spacing matrix ID 804. In one or more embodiments, the spacing matrix ID may be a text string that may be up to 15 characters in length. Other suitable formats and character lengths may be used. One or more other items 806 may be included in the header record 802 to further annotate or clarify the spacing matrix 800. For example, a unique numeric ID for tracking purposes, a reference date, a time stamp of the last time information was used to generate the matrix, a destination airspace facility for all flights in the list, a list of metering fixes referenced, and an expiration time. Other suitable items may be included. As used herein, the terms “meter point” and “meter fix” may be used interchangeably.

In one or more embodiments the spacing matrix 800 may include a plurality of spacing records 808 (FIG. 8A and FIG. 8B). The spacing record 808 may contain a leading flight ID 810, a trailing flight ID 812, and a target spacing 814. In one or more embodiments, the target spacing 814 may be in seconds or any other suitable denomination. The spacing record 808 may include one or more other suitable parameters. For example, human readable aircraft type, aircraft names, destination airport, flight metering fixes, landing runways, operational procedures, and operational procedure types. Other suitable parameters may be included.

The embodiments described herein may be implemented to provide for target spacing for related flight pairs for operations in the en-route airspace. As used herein, “related” means that during a period of time, without limiting its duration or time of occurrence, the two flights may become a concern in terms of spacing within the en-route airspace. That is, they become a concern in terms of spacing prior to entering their respective destination terminal areas. Examples may include but are not limited to: flights merging on to the same en-route RNAV route, crossing a traffic flow choke point in the en-route airspace, or entering the same en-route airspace sector. In one or more embodiments, the airspace model 222 (FIG. 2) may be a model of a volume of en-route airspace that may or may not include underlying terminal areas. The airspace model 222 may model high altitude routes, en-route meter points, departures, reference en-route flight paths, and en-route spacing vectors. In one or more embodiments en-route meter points may be points near the boundary of the departure terminal airspace where the departure traffic flow may be regulated into the en-route airspace. In one or more embodiments, an en-route meter point may be any selected point. In one or more embodiments, the en-route meter point may be varied to achieve the goals of different control strategies to balance a robustness of flow control in en-route airspace, and the expected benefits of the flow control, such that this may be a control mechanism.

The embodiments described herein may be implemented to provide for target spacing for related flight pairs departing from a terminal area. As used herein, “related” means that during a period of time, without limiting its duration or time of occurrence, the two flights may become a concern in terms of spacing within the departure terminal area and/or within the en-route airspace around the departure terminal area. Examples may include but are not limited to: flights merging on to the same departure RNAV route connected to en-route operations, crossing a departure area or a point or a volume of other airspace around the boundary of the departure terminal area, merging into an overhead en-route flow, or entering the same en-route airspace sector. In one or more embodiments, the airspace model 222 (FIG. 2) may be a model of the departure terminal area that may or may not be extended to the surrounding en-route airspace. The airspace model 222 may model aerodromes, departure meter points, departure areas, departures, high altitude routes, radar sites, reference departure paths, and departure spacing vectors that extend into en-route airspace. In one or more embodiments departure meter points may be departure runway thresholds where the take-off flights may be regulated into departure flows. In one or more embodiments, a departure meter point may be any selected point within or surrounding the departure terminal airspace. In one or more embodiments, the departure meter point may be varied to achieve the goals of different control strategies to balance a robustness of flow control for departure flows, and the expected benefits of the flow control, such that this may be a control mechanism.

The embodiments described herein may be implemented to provide for target spacing for related flight pairs taxiing out to runways for take-off. As used herein, “related” means that during a period of time, without limiting its duration or time of occurrence, the two flights may become a concern in terms of spacing on the airport surface. Examples may include but are not limited to: flights merging on to the same segment of taxi way, crossing a taxi way intersection, entering a take-off queue, or take-off time at the runway threshold. In one or more embodiments, the airspace model 222 (FIG. 2) may be a model of the aerodrome. The airspace model 222 may model terminal gates and parking ramps, taxi meter points, taxi ways, runways, taxi way intersections, runway crossing points, reference taxi paths, and taxi spacing vectors. In one or more embodiments, taxi meter points may be entrances to taxi ways, taxi way intersections, and/or runway crossing points where the flights may be regulated into runways for take-off. In one or more embodiments, a taxi meter point may be any selected point on the airport surface. In one or more embodiments, the taxi meter point may be varied to achieve the goals of different control strategies to balance a robustness of flow control for take-off, and the expected benefits of the flow control, such that this may be a control mechanism. In one or more embodiments, the trajectory modeler module 230 may perform probabilistic taxi trajectory prediction. In one or more embodiments, the trajectory modeler module 230 may verify if the aircraft is auto-taxi capable, so that either an auto-taxi prediction or a conventional manual controlled taxi prediction may be executed.

The embodiments described herein may be implemented as standalone systems to provide for target spacing for arrivals, en-route operations, departures, or airport taxiing operations. As used herein, “standalone” means that a system is solving the problem within its domain of operations, without limiting information exchange among standalone systems. The embodiments described herein may be implemented as integrated systems to provide for target spacing for flights from taxi out, to departure, to en-route, and to arrivals. In integrated systems, departure operations consider possible operations in en-route operations and arrival operations, en-route operations also consider possible arrival operations, thus making the gate-to-gate operation for a flight more robust.

Note the embodiments described herein may be implemented using any number of different hardware configurations. For example, FIG. 9 illustrates a spacing advisor platform 900 that may be, for example, associated with the system 200 of FIG. 2. The spacing advisory platform 900 comprises a processor 910 (“processor”), such as one or more commercially available Central Processing Units (CPUs) in the form of one-chip microprocessors, coupled to a communication device 920 configured to communicate via a communication network (not shown in FIG. 9). The communication device 920 may be used to communicate, for example, with one or more users. The spacing advisor platform 900 further includes an input device 940 (e.g., a mouse and/or keyboard to enter information) and an output device 950 (e.g., to output and display the assessment and recommendation).

The processor 910 also communicates with a memory/storage device 930. The storage device 930 may comprise any appropriate information storage device, including combinations of magnetic storage devices (e.g., a hard disk drive), optical storage devices, mobile telephones, and/or semiconductor memory devices. The storage device 930 may store a program 912 and/or processing logic 914 for controlling the processor 910. The processor 910 performs instructions of the programs 912, 914, and thereby operates in accordance with any of the embodiments described herein. For example, the processor 910 may receive data and then may apply the instructions of the programs 912, 914 to determine a method for improving a spacing.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

As used herein, information may be “received” by or “transmitted” to, for example: (i) the platform 900 from another device; or (ii) a software application or module within the platform 900 from another software application, module, or any other source.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors 910 (FIG. 9). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A method comprising:
receiving airspace data, weather data, and flight data at a spacing advisor module, the airspace data, weather data and flight data related to a plurality of flights;
generating, via a trajectory modeler, a predicted trajectory for each of the flights of the plurality of flights to a target area;
calculating a desired spacing for at least one of the points along a reference flight path;
manipulating a trajectory for at least one of the first flight and the second flight based on the desired spacing;
generating a target spacing, via the spacing advisor module, associated with a first flight and a second flight of the plurality of flights based on the received data, the generated predicted trajectory, and the manipulation of the predicted trajectory, wherein the target spacing is a distance between the second flight and a second meter point when the first flight passes a first meter point; and
operating at least one of a first aircraft associated with the first flight and a second aircraft associated with the second flight based on the generated target spacing.

2. The method of claim 1, wherein calculation of desired spacing further comprises:
receiving separation minima, wake vertex requirements, and flow rate considerations, and calculation of a plurality of separation buffers for at least one of the points along the reference flight path.

3. The method of claim 2, wherein calculation of the separation buffer is based on an uncertainty associated with the predicted trajectory.

4. The method of claim 3, wherein the uncertainty is based on a probability of one or more personality parameters for an aircraft performing the flight, a probability associated with the weather data, and a probability associated with pilot actions.

5. The method of claim 1, wherein manipulation of the trajectory further comprises:
shifting the trajectory along a time axis to achieve the desired spacing.

6. The method of claim 1, wherein the first flight and the second flight are a related pair by being, for a period of time without limit to duration or when occurring, a navigation spacing concern to each other in a proximity of the target area.

7. The method of claim 1 further comprising:
determining a head time for the second flight relative to the second meter point, wherein the head time is a difference in time between when the second flight will cross the second meter point and the first flight will cross the first meter point.

8. The method of claim 1, further comprising:
generating a spacing matrix including target spacing entries for all possible flight pairs in a given time window, wherein a flight pair is an ordered sequence of two flights, and wherein a probability the flight pair will be a navigation spacing concern exceeds a threshold.

9. The method of claim 1, wherein the target spacing is determined in real-time for currently active flights.

10. The method of claim 1, wherein each of the airspace data, weather data, and flight data is received from at least one of an external source, an internal data store, and models.

11. A system comprising:
a configuration manager module to receive data, the configuration manager module operative to use the received data to:
track a plurality of flights in a flight list via a flight list module;
update an airspace model;
update a weather model;
a trajectory modeler operative to receive data from the configuration manager and update a flight trajectory for one or more flights in the flight list;
a memory for storing program instructions;
a spacing advisory tool processor, coupled to the memory, and in communication with the configuration manager module and the trajectory modeler and operative to execute program instructions to:
receive data from the configuration manager and the trajectory modeler;
calculate a desired spacing for at least one of the points along a reference flight path;
manipulate a trajectory for at least one of the first flight and the second flight based on the desired spacing; and
generate a target spacing associated with a first flight and a second flight of the plurality of flights, wherein the target spacing is a distance between the second flight and a second meter point when the first flight passes a first meter point; and
an optimizer to adjust operation of at least one of a first aircraft associated with the first flight and a second aircraft associated with the second flight is based on the generated target spacing.

12. The system of claim 11, wherein calculation of desired spacing further comprises:
receiving separation minima, wake vertex requirements, and flow rate considerations, and calculation, via the trajectory modeler, of a plurality of separation buffers for at least one of the points along the reference flight path.

13. The system of claim 12, wherein calculation of the separation buffer is based on an uncertainty associated with the predicted trajectory.

14. The system of claim 11, wherein manipulation of the trajectory further comprises:
shifting the trajectory along a time axis to achieve the desired spacing.

15. The system of claim 11, wherein the first flight and the second flight are a related pair by being, for a period of time without limit to duration or when occurring, a navigation spacing concern to each other in a proximity of the target area.

16. The system of claim 11, wherein the spacing advisory tool processor is further operative to execute program instructions to:
determine a head time for the second flight relative to the second meter point, wherein the head time is a difference in time between when the second flight will cross the second meter point and the first flight will cross the first meter point.

17. The system of claim 11, wherein the spacing advisory tool processor is further operative to execute program instructions to:
generate a spacing matrix including target spacing entries for all possible flight pairs in a given time window, wherein a flight pair is an ordered sequence of two flights, and wherein a probability the flight pair will be a navigation spacing concern exceeds a threshold.

18. The system of claim 11, wherein the target spacing is determined in real-time for currently active flights.

19. A non-transitory computer-readable medium storing instructions that, when executed by a computer processor, cause the computer processor to perform a method comprising:
receiving airspace data, weather data, and flight data at a spacing advisor module, the airspace data, weather data and flight data related to a plurality of flights;
generating, via a trajectory modeler, a predicted trajectory for each of the flights of the plurality of flights to a target area;
calculating desired spacing for at least one of the points along a reference flight path;
manipulating a trajectory for at least one of the first flight and the second flight based on the desired spacing;
generating a target spacing, via the spacing advisor module, associated with a first flight and a second flight of the plurality of flights based on the received data and the generated predicted trajectory, wherein the target spacing is a distance between the second flight and a second meter point when the first flight passes a first meter point; and
operating at least one of a first aircraft associated with the first flight and a second aircraft associated with the second flight based on the generated target spacing.

20. The medium of claim 19, wherein calculation of desired spacing further comprises:
receiving a radar separation minima, wake vertex requirements, and flow rate considerations, and calculation of a plurality of separation buffers along the reference flight path.

21. The medium of claim 19, wherein the first flight and the second flight are a related pair by being, for a period of time without limit to duration or when occurring, a navigation spacing concern to each other in a proximity of the target area.

22. The medium of claim 21 further comprising:
determining a head time for the second flight relative to the second meter point, wherein the head time is a difference in time between when the second flight will cross the second meter point and the first flight will cross the first meter point.
